(19) United States
(12) Patent Application Publication
(10) Pub. No.: US 2004/0263899 A1
(43) Pub. Date: Dec. 30, 2004

(54) Systems and methods for monitoring an imaging job in a computer system

(76) Inventor: Andrew R. Ferlitsch, Tigard, OR (US)

Correspondence Address: Wesley L. Austin, Madson & Metcalf, Suite 900, 15 West South Temple, Salt Lake City, UT, 84101, US

(21) Appl. No.: 10/602,485

(22) Filed: Jun. 24, 2003

(51) Int. Cl. G06F 3/12; G06F 11/30; G06F 13/00; G06F 15/163

(52) U.S. Cl. 358/1.15; 709/245; 710/19

(57) ABSTRACT

A system for monitoring an imaging job in a computer system is disclosed. The system includes a computing device and an imaging device in electronic communication with the computing device. Executable instructions are configured to send an imaging job to an imaging device. A background process is created for monitoring the status of the imaging job. The background process is initiated by a despooling subsystem. The network address of a computing device is obtained. A status message is sent to the computing device using the network address. The status message is received by the background process.

### TECHNICAL FIELD

The present invention relates generally to printing through use of a computer. More specifically, the present invention relates to systems and methods for print job monitoring, recovery and accounting in a computer system.

### BACKGROUND

Computer and communication technologies continue to advance at a rapid pace. Indeed, computer and communication technologies are involved in many aspects of a person's day. For example, many devices being used today by consumers have a small computer incorporated within the device. These small computers come in varying sizes and degrees of sophistication. These small computers may vary in sophistication from one microcontroller to a fully-functional complete computer system. For example, small computers may be a one-chip computer, such as a microcontroller, a one-board type of computer, such as a controller, a typical desktop computer, such as an IBM-PC compatible, etc.

Printers are used with computers to print various kinds of items including letters, documents, pictures, etc. Many different kinds of printers are commercially available. Ink jet printers and laser printers are fairly common among computer users. Ink jet printers propel droplets of ink directly onto the paper. Laser printers use a laser beam to print.

Printers are a type of imaging device. Imaging devices include, but are not limited to, physical printers, multi-functional peripherals, a printer pool, a printer cluster, a fax machine, a plotter, a scanner, a logical device, a computer monitor, a file, etc.

Different kinds of computer software facilitate the use of imaging devices. The computer or computing device that will be used to print the materials typically has one or more pieces of software running on the computer that enable it to send the necessary information to the printer to enable printing of the materials. If the computer or computing device is on a computer network there may be one or more pieces of software running on one or more computers on the computer network that facilitate printing.

In certain computing environments, it is desirable receive information back from the imaging device that relates to each imaging job. The information that is tracked may be used for a variety of reasons including, but not limited to, knowing whether the imaging job was successful or if it had any problems. If there were any problems with the imaging job, receiving information about the problems may enable the computing device to perform corrective action or job recovery. Benefits may be realized by providing increased functionality t6 the software used in processing imaging jobs.

### BRIEF DESCRIPTION OF THE DRAWINGS

The present embodiments will become more fully apparent from the following description and appended claims, taken in conjunction with the accompanying drawings. Understanding that these drawings depict only typical embodiments and are, therefore, not to be considered limiting of the invention's scope, the embodiments will be described with additional specificity and detail through use of the accompanying drawings in which:

FIG. 1 is a block diagram illustrating the major hardware components typically utilized in a computing device used with embodiments herein;

FIG. 2 is a hardware and software block diagram illustrating an environment in which the present systems and methods may be implemented;

FIG. 3 is a flow diagram of an embodiment of an improved method for imaging job monitoring and job recovery;

FIG. 4 is a block diagram of an embodiment of a system for imaging job monitoring and job recovery;

FIG. 5 is a flow diagram of another embodiment of an improved method for imaging job monitoring and job recovery;

FIG. 6 is a block diagram of another embodiment of a system for imaging job monitoring and job recovery; and

FIG. 7 is a flow diagram of another embodiment of an improved method for imaging job monitoring and job recovery.

### DETAILED DESCRIPTION

A system for monitoring an imaging job in a computer system is disclosed. The system includes a computing device and an imaging device in electronic communication with the computing device. Executable instructions are configured to send an imaging job to an imaging device. A background process is created for monitoring the status of the imaging job. The background process is initiated by a despooling subsystem. The network address of a computing device is obtained. A status message is sent to the computing device using the network address. The status message is received by the background process.

A method for monitoring an imaging job in a computer system is also disclosed. An imaging job is sent to an imaging device. A background process is created for monitoring the status of the imaging job. The network address of a computing device is obtained. A status message is sent to the computing device using the network address. The status message is received by the background process.

In one embodiment of the method for monitoring an imaging job, returning to a print spooler is delayed until after the imaging job is completed. In addition, control of descheduling and clearing of the imaging job may be taken from a print spooler by a print processor.

The imaging device may be any kind of device for imaging including, but not limited to, a printer, a scanner, a fax machine, a copier and a document server. Many different kinds of protocols may be used for communications between the computing device and the imaging device.

The network address may be obtained in a variety of ways. In an embodiment, the network address may be embedded in the imaging job. The network address may also be extracted from a connection. The network address may also be sent from the computing device to the imaging device.

The status message may include an identifier that enables the computing device to direct the status message to the processing listening for the message. The identifier may include, but is not limited to, a port, a file, a directory, an FTP address, an SNMP trap and an email address.

A print processor may be notified of the status message after the status message has been received by the background process. The background process may be terminated after it has served its purpose. In certain embodiments, the background process may perform descheduling and clearing of the imaging job. In addition, the background process runs asynchronously.

Control may be returned back to the print spooler and success/failure of the imaging job may be indicated to the print spooler. Job recovery may be performed by the print spooler if the job recovery is necessary.

The method for monitoring an imaging job in a computer system may be embodied in a variety of implementations. The method may be implemented through a set of executable instructions for implementing a method in a computing device. The set of instructions may be stored on a computer-readable medium.

It will be readily understood that the components of the embodiments as generally described and illustrated in the Figures herein could be arranged and designed in a wide variety of different configurations. Thus, the following more detailed description of the embodiments of the systems and methods of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Several aspects of the embodiments described herein will be illustrated as software modules or components stored in a computing device. As used herein, a software module or component may include any type of computer instruction or computer executable code located within a memory device and/or transmitted as electronic signals over a system bus or network. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction, or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

Note that the exemplary embodiment is provided as an exemplar throughout this discussion, however, alternate embodiments may incorporate various aspects without departing from the scope of the present invention.

The order of the steps or actions of the methods described in connection with the embodiments disclosed herein may be changed by those skilled in the art without departing from the scope of the present invention. Thus, any order in the Figures or detailed description is for illustrative purposes only and is not meant to imply a required order.

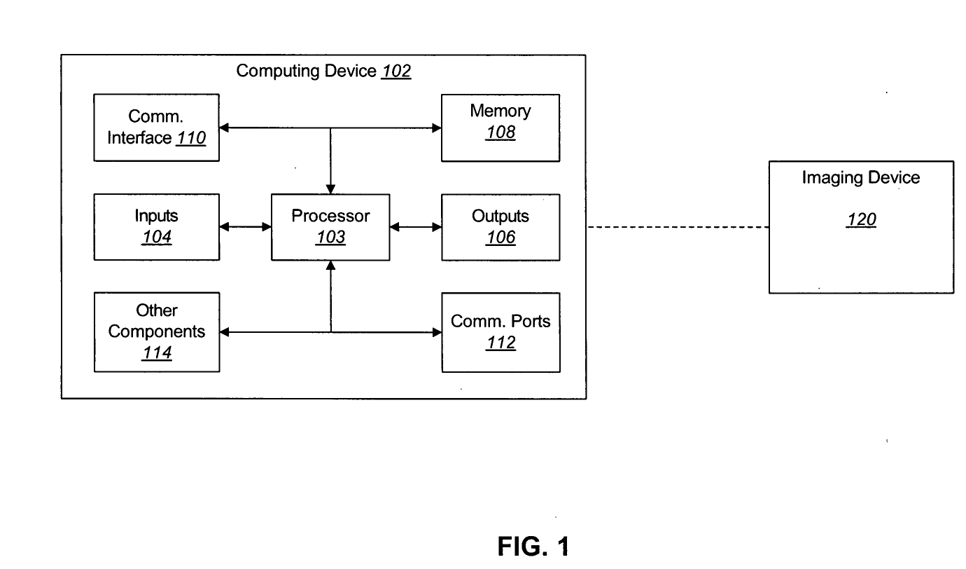

FIG. 1 is a block diagram illustrating the major hardware components typically utilized with embodiments herein. The systems and methods disclosed may be used with a computing device 102 and an imaging device 120. Computing devices 102 are known in the art and are. commercially available. The major hardware components typically utilized in a computing device 102 are illustrated in FIG. 1. A computing device 102 typically includes a processor 103 in electronic communication with input components or devices 104 and/or output components or devices 106. The processor 103 is operably connected to input 104 and/or output devices 106 capable of electronic communication with the processor 103, or, in other words, to devices capable of input and/or output in the form of an electrical signal. Embodiments of devices 102 may include the inputs 104, outputs 106 and the processor 103 within the same physical structure or in separate housings or structures.

The electronic device 102 may also include memory 108. The memory 108 be a separate component from the processor 103, or it may be on-board memory 108 included in the same part as the processor 103. For example, microcontrollers often include a certain amount of on-board memory.

The processor 103 is also in electronic communication with a communication interface 110. The communication interface 110 may be used for communications with other devices 102. Thus, the communication interfaces 110 of the various devices 102 may be designed to communicate with each other to send signals or messages between the computing devices 102.

The computing device 102 may also include other communication ports 112. In addition, other components 114 may also be included in the electronic device 102.

Of course, those skilled in the art will appreciate the many kinds of different devices that may be used with embodiments herein. The computing device 102 may be a one-chip computer, such as a microcontroller, a one-board type of computer, such as a controller, a typical desktop computer, such as an IBM-PC compatible, a Personal Digital Assistant (PDA), a Unix-based workstation, etc. Accordingly, the block diagram of FIG. 1 is only meant to illustrate typical components of a computing device 102 and is not meant to limit the scope of embodiments disclosed herein.

The computing device 102 is in electronic communication with the imaging device 120. Imaging devices include, but are not limited to, physical printers, multi-functional peripherals, a printer pool, a printer cluster, a fax machine, a plotter, a scanner, a logical device, a computer monitor, a file, etc. Imaging devices are well known by those skilled in the art.

In light of the definition of an imaging device 120 above, the term imaging job, as used herein, is broadly defined as any instruction or set of instructions that are sent to an imaging device to cause an image to be printed, imaged, scanned, sent, etc., to or from the imaging device 120. Thus, the term imaging job includes, but is not limited to, a fax instruction or job to send a fax, a print job to print to a file, a print job to print to a particular window in a graphical user interface, a scan job to scan in an image from a scanner, a print job to print to a physical printer, etc.

When a print job is printed from a computing device 102 to a digital imaging device 120, or a scan job is scanned from a digital imaging device 120 to a computing device 102, or a fax job is sent from/to, or a document job is sent from/to, a digital imaging device 120, through a print/scan/fax/document subsystem, an error could occur prior to the completion of the job on the recipient side without the error being reported back to the sender and without the opportunity for the sender to take corrective action. The systems and methods herein provide means by which the error may be reported back to the sender and embodiments also provide opportunities for the sender to take corrective action.

Traditionally, the print subsystem on a computing system, such as illustrated by the Microsoft Windows family of operating systems, only monitors portions, but not all, of the process of printing an image on paper to a peripheral device. For example, in the Microsoft Windows family of operating systems, a user typically prints a document by opening the document in an associated application and selecting File->Print. The application then converts the document data to a device independent format (i.e., GDI for Graphics Device Interface) and passes the device independent data to the printer driver associated with selected printer. The printer driver then converts (i.e., rendering) the device independent data to device dependent format (e.g., PCL, Postscript) that is compatible with the printing device. The device dependent data (i.e., print data) is then spooled to the print spooler and the print spooler places the print data in storage for subsequent despooling to the printing device.

The process of spooling and despooling the print data are separate processes. In this manner, the printer driver can return control back to the user's application after the print data has been spooled by the spooler without waiting for the print data to be printed on the printer. If an error occurs prior to the completion of the spooling of the print data, the error would be propagated back to the driver/application and the user could take corrective action, if any.

The print spooler then, immediately or delayed, despools the print job to the print processor. If the print job is journaled data (e.g., EMF—Enhanced Metafile Format), the print processor will playback the print data to the corresponding printer driver, which will render the journaled data and respool the render print job to the print spooler. Otherwise, the print processor will despool the rendered print data to the corresponding printing device. In some print subsystems, a customized print processor may be used to performed proprietary actions related to the print job as well as the standard behavior.

If an error occurs despooling the print data from the spooler to the print processor, or when the print processor is despooling the print data to the printing device, or when the print processor is playing back the journaled data to the corresponding printer driver, that error is reported back to the print spooler.

Depending on the printing protocol (e.g., LPR), the port manager does not return control back to the print processor until the print job has been raster image processed (RIP) on the printing device. RIP stands for Raster Image Processed or Processor. A RIP is a process that takes imaging data (e.g., PDL) and converts it into a bitmap for printing. The print processor then returns control back to the print spooler, indicating to the print spooler that the print job has completed successfully, and the spooler deletes the scheduled print job and any associated resources (e.g., spool file). If an error occurs during the RIP process, this error is propagated, via the printing protocol and print processor, back to the print spooler.

If an error is reported back to the print spooler, the print spooler can notify the user and take corrective action, if any. For example, if the connection to the printing device during transmission of the print data timed out, the spooler might notify the user and ask the user if they like to retry. If so, the print job is again despooled by the print spooler. Other errors may cause the spooler to preserve the spool data and other associated job scheduling information and attempt to prompt the user at a later point for retry, such as after a system reboot.

Some custom print processors may also take corrective action in place of the print spooler. For example, this print processor may attempt to automatically rollover the print job to another available compatible printer that is part of the same printer pool.

The traditional manner for monitoring and job recovery by the Microsoft Windows print subsystems continue to be deficient in the following ways. An error occurring after the print job is RIP'ed and is being printed, such as a paper jam, could be handled in a more efficient manner.

Improvements could also be made to assist when an error occurs after the print job is despooled from a print server (i.e., network printing) to a printing device. In a shared printing environment, where a print job is despooled to a print queue on a print server, the print server appears as the printing device to the local print processor. Thus, when the print job is successfully queued on the print server, the print job is reported back to the local print processor/spooler as successfully printed. If an error occurs after the print job is despooled from the print server to the printing device, such as a despooling or RIP error, the error is reported back to the print processor/spooler on the print server. The print server spooler then has to take corrective action, which may not be reported back to the user (client) for intervention.

Error handling systems could also be modified for an error occurring after a print job is de-queued for printing from an internal queue in the printing device. This applies to printers that have capabilities to queue simultaneous jobs on the printer by storing the jobs to internal storage. The internal queue/storage operates as an internal print server/spooler. Thus, when the job is successfully queued on the printer, the print job is reported back to the local print processor/spooler as successfully printed. If the error occurs during de-queuing or RIP, the error is reported back to the internal server/spooler. The printer then has to take corrective action, if any, which may not be reported back to the user (client) for intervention.

The network address of the local client may be embedded in the print job and a monitoring process may run in the background on the client machine. When the printer successfully outputs the print job, or detects an error, a message indicating the status of the job is sent back to the monitoring device on the local client machine, obtained from the network address embedded in the print job.

Job identification information may be embedded in the print job and a monitoring process may be running that listens and registers a document specific SNMP (Simple Network Management Protocol) trap with the device for events related to the device or job. When the printer successfully outputs the print job, or detects an error, an SNMP document specific message indicating the status of the job is sent back to the monitoring device on the local client machine along with the job identification information.

In another embodiment, the email address of the user initiating the print job is embedded in the print job. When the printer successfully outputs the print job, or detects an error, an email message is sent back to the user. This method would lack several benefits. For example, the message is not real-time. The user also may need to poll the email server. Further, the email is not integrated with print spooler/subsystem. The print spooler cannot take corrective action. In addition, the print job would have already been deleted by the spooler. The user would have to manually take corrective action, if any.

A custom print spooler may be used. A custom print spooler may be used to communicate with the printing device about the status of a print job after it has been despooled to the printing device. Two methods of communication may be used. In an example of the first method, the print spooler periodically polls the printing device using SNMP. The printer is presumed to support a SNMP job MIB (Management Information Base) extension. During each poll, the print spooler queries the printing device for the OID (Object Identifier) values of a job MIB relating to the despooled job.

In an example of another method of communication the custom print spooler may register an SNMP trap with the printing device to respond back with job MIB events. When the job is completed, or the status otherwise changes, such as in a paper jam, the printing device would send a message back to the custom spooler.

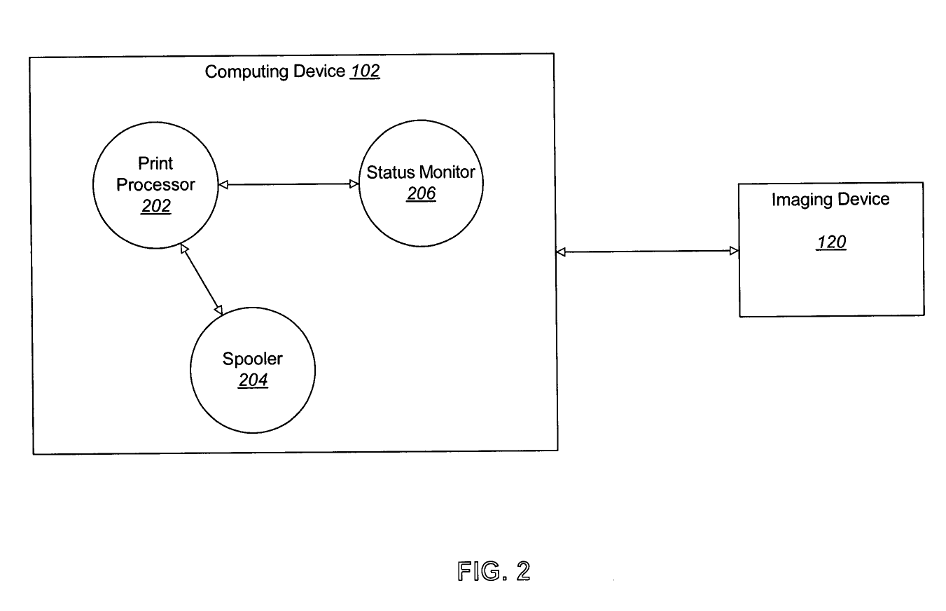

FIG. 2 is a hardware and software block diagram illustrating an environment in which the present systems and methods may be implemented. The computing device 102 is in electronic communication with the imaging device 120 so that it may send imaging jobs to the imaging device 120 and receive communications back from the imaging device 120.

A print processor 202 and spooler 204 are shown running on the computing device 102. The software processes 202, 204, 206 shown on the computing device 102 may also be distributed across a computer network (not shown) such that one or more of the processes are running on one or more computing devices 102. Thus, it is not necessary that all the processes run on the same computing device 102. A status monitor 206 is used to monitor the status of the imaging job. Further details about the operation of the processes will be discussed below. The systems and methods herein may be integrated with the pre-existing print spooler subsystem. In addition, they may be configured or programmed with the ability to take corrective action.

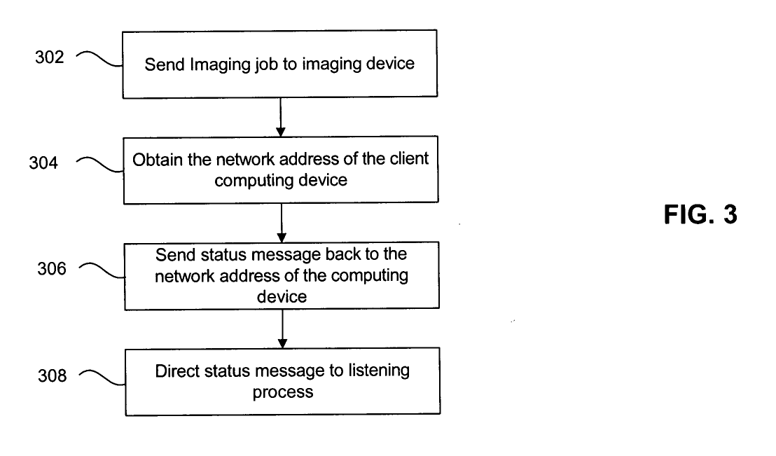

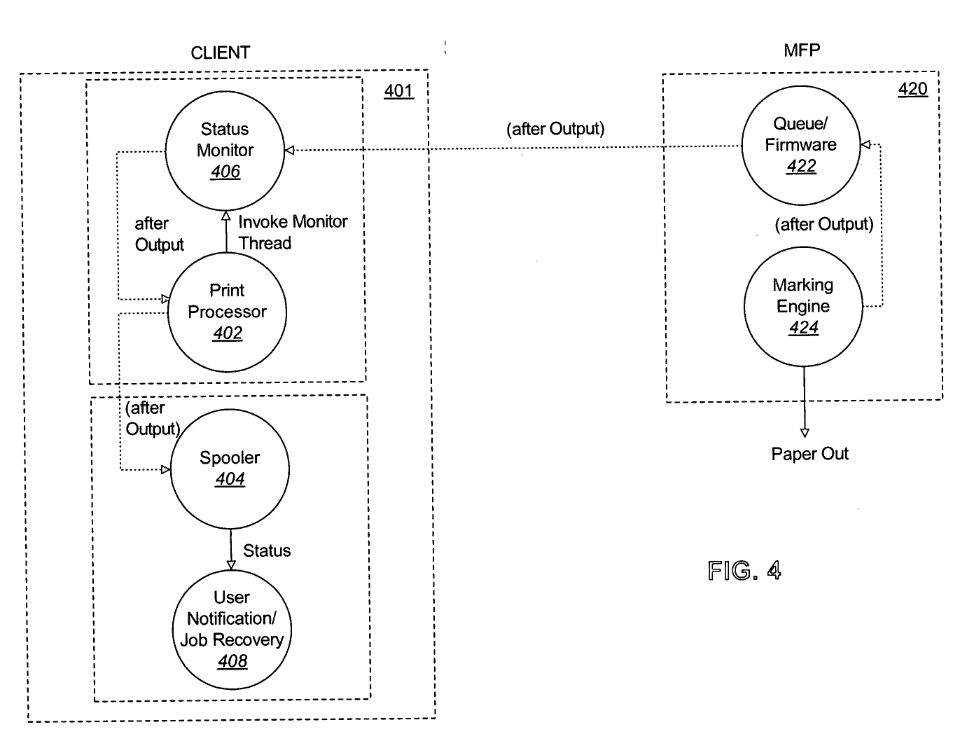

FIG. 3 is a flow diagram of an embodiment of an improved method for imaging job monitoring and job recovery. An imaging job is sent 302 to an imaging device. The network address of the client computing device is obtained 304. A status message is sent 306 back to the network address of the computing device. The status message is directed 308 listening process. In one embodiment, the listening process is the status monitor 206. More specific embodiments will be discussed below in relation to FIGS. 4-7.

The following embodiments, shown in FIGS. 4-7, offer several advantages. The system monitors job completion and errors after the job has been RIP'ed on the printing device. In one embodiment, the return from the print processor is delayed until after the job is completed. This results in the behavior of the print spooler for job notification and recovery extended to the end of outputting a print job. In another embodiment, the print processor takes control of the descheduling and clearing of a print job from the print spooler and creates a background thread which monitors the print job until the end of outputting a print job.

The system also provides the advantage of monitoring job completion and errors after a job has been despooled from a print server. In this embodiment, the print processor takes control of the descheduling and clearing of a print job from the print spooler and creates a background thread which monitors the print job until the end of outputting a print job.

The system may also monitor job completion and errors after a job has been despooled for rasterization from a print queue that is internal to the printing device. In this embodiment, the print processor takes control of the descheduling and clearing of a print job from the print spooler and creates a background thread which monitors the print job until the end of outputting a print job.

A further advantage is that the system monitors job completion and errors until a job is completed (e.g., outputted or imaged) for other image processing which use the print spooler and print processor. Scan jobs may be scheduled and sent through the print spooler and print processor. Fax jobs may be scheduled and sent through the print spooler and print processor.

Herein references to jobs performed by a multi-functional peripheral (“MFP”), such as printing, scanning, faxing and copying, and document management will be referred to as imaging jobs. In addition, references to devices that receive or transmit an imaging job, such as an MFP or computing device, will be referred to as imaging devices. Print jobs and printing devices are used to illustrate exemplary embodiments, but other kinds of imaging jobs and imaging devices may be used in implementations of the embodiments disclosed herein.

The embodiments disclosed operate independently of how the imaging job is initiated. For example, a print job may be initiated by an application using a printer driver which spools a print job to the print spooler.

The embodiments disclosed also operate independently of the protocol used between the client computing and imaging device to obtain the job completion status. For example, the protocol may be a proprietary protocol over TCP/IP. Although Sharp's proprietary NJR (notify job return) protocol over TCP/IP will be used to illustrate the various embodiments, other protocols may also be used.

The embodiments are independent of the means that the printing device, and/or client device obtains the network communication (e.g., network) address of the other device to establish the communication channel. For example, the IP address of the client computing device may be embedded in the print job. Sharp's family of digital imaging printer drivers which embed the IP address and NJR port in the print job will be used to illustrate this embodiment, but other printer drivers may be used as well as other means for obtaining the network communication address.

The printing device is able to obtain the network address of the client computing device 102 of the print job that is currently being printed. The network address may be obtained in a variety of ways. For example, the network address may be obtained from the print job. The network address may be embedded in the print job. By way of further example, the network address may be obtained from the connection. The network address may be obtained by examining the sender address. The network address may also be communicated from the client computing device 102 via another connection.

As the print job is processed, the printing device sends at least one status message or completion response back to the network address of the client computing device 102. The response or connection means has an identifier enabling the client computing device 102 to direct the response to the appropriate process listening for the response. This identifier may include, but is not limited to, a port (e.g., socket port), a file or directory, an FTP address, an SNMP trap and/or an email address.

The status message or completion response is sent when the print job has successfully outputted the print job or when an error occurs. The printing device may optionally send other responses which may include, but are not limited to, when the RIP process begins, when the RIP process ends, when each page is RIP'ed, when each page is outputted and/or when an error is recovered.

Each response may also contain additional information, such as, but not limited to, print options, action taken to recover job, date and time and/or consumables used. The response may also be additionally secured, such as by encryption by either the transport or data layer, or both.

Referring now to FIG. 4, in this embodiment the print processor 402 creates a background thread, which is a background process, shown as the status monitor 406, for monitoring the completion status and waits on the termination of the thread in the main thread before returning control back to the print spooler 404.

The imaging device 420 may include a queue 422 and a marking engine 424. The queue 422 may be implemented in firmware and operates to queue up messages/status from the imaging device 420, which may involve receiving data from the marking engine 424. The data sent from the marking engine 424 to the queue 422 is typically sent after the imaging device 420 has completed its task and is indicative of the status of the operation or job. The marking engine 424 in a printer causes the printing to occur which results in a printed document or paper.

The background thread 406 monitors the printing device 420 for the completion status responses. When the background thread 406 receives the completion response, success or failure, the background thread 406 notifies the print processor 402 of the response and terminates. Notification of the response from the background thread 406 to the main thread may occur in any manner, such as, but not limited to, shared memory, a message, the registry and/or file information.

The print processor 402 then returns control back to the print spooler 404 indicating the success/failure of the print job. While in one embodiment the print spooler 404 would perform any additional corrective action, the print processor 402 may also perform some job recovery, if any. The print spooler 404 may use the status for user notification 408 and/or job recovery.

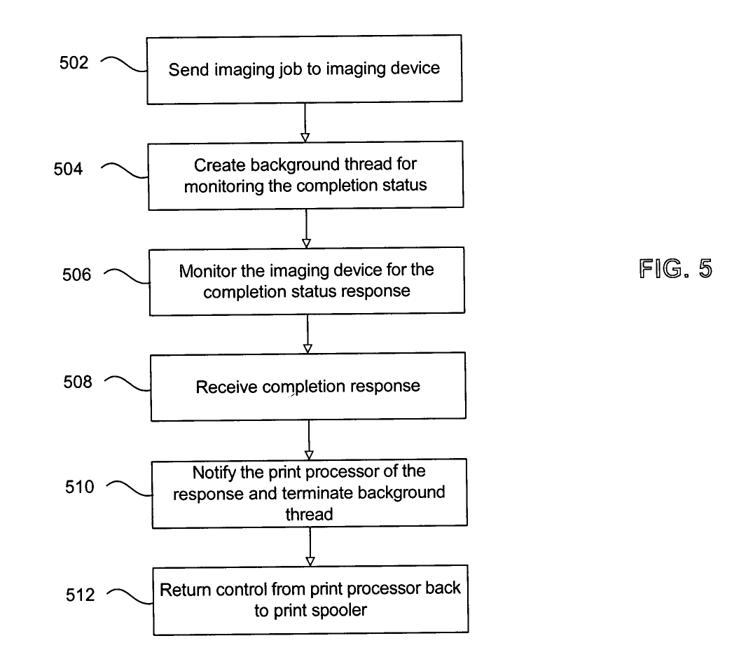

FIG. 5 is a flow diagram of another embodiment of an improved method for imaging job monitoring and job recovery. An imaging job is sent 502 to an imaging device. A background thread is created 504 for monitoring the completion status. The background thread is initiated by the despooling subsystem, which can then react to status changes by modifying or redirecting the print stream. The imaging device is monitored 506 for the completion status response. The completion response is received 508. Once the completion response is received 508, the print processor is notified 510 of the response and the background thread is terminated. Control is returned 512 from the print processor back to the print spooler.

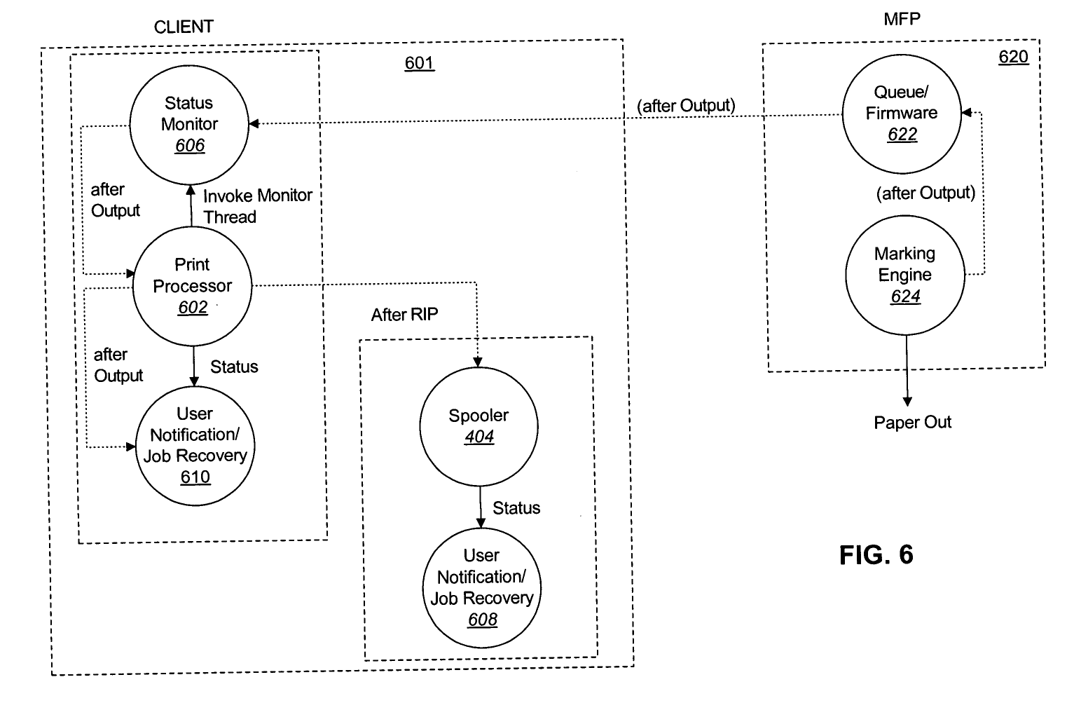

Referring now to FIG. 6, in this embodiment the print processor 602 creates a background thread 606, or status monitor 606, for monitoring the completion status and does not wait on the termination of the thread in the main thread before returning control back to the print spooler 604. Instead, the print processor 602 takes control from the print spooler 604 of descheduling and cleaning up spool files. One such method is for the print processor 602 to lock the spool and spool associated files from deletion. When the print processor 602 returns control back to the print spooler 604 (e.g., after the job has been RIP'ed), the print spooler 604 is unable to delete the spool files because of the lock. In another embodiment, the print processor 602 may change the names of the spool and associated files and create dummy files in their place. These are examples, and are not otherwise meant to limit the scope in which the print processor 602 takes control of the descheduling and cleaning up spool files from the print spooler 604.

Control of the descheduling and cleaning up spool files is then handled by the background thread 606 created by the print processor 602 that runs asynchronously.

When the background thread 606 receives the completion response, success or failure, the background thread 606 then performs the appropriate action. If the job completed successfully, the background thread 606 then deschedules and cleans up the spool related files in an appropriate manner. The background thread 606 may additionally notify the user of the successful job completion.

If the job fails, the background thread 606 performs job recovery 610, if any. Performing job recovery 610 may include, but is not limited to, notification to the user, waiting on corrective action, restarting the job on another device (i.e., rollover) and/or restarting the job at another time.

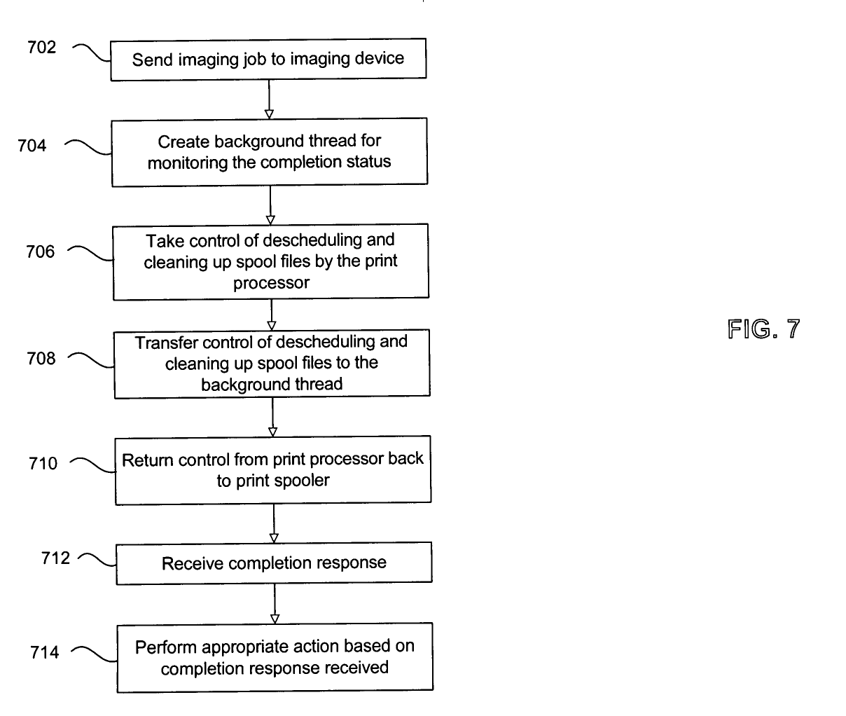

FIG. 7 is a flow diagram of another embodiment of an improved method for imaging job monitoring and job recovery. An imaging job is sent 702 to an imaging device. A background thread is created 704 for monitoring the completion status. Control is assumed 706 of descheduling and cleaning up spool files by the print processor. Then control of descheduling and cleaning up spool files is transferred 708 to the background thread. Control is then returned 710 from the print processor back to the print spooler. At some time the completion response is received 712. The system may then perform 714 appropriate action based on the completion response received.

The different steps in the flow diagram herein may be performed in various orders. In addition, some of the steps may be performed in parallel. Only in cases where one action may not be started until another has been completed is there any specific order that is necessary.

The systems and methods disclosed herein may be implemented in various ways, including embodiments where they are part of the operating system or where they are not part of the operating system. In addition, the system may comprise more than one software component, or the functionality of the systems and methods may be achieved by one or more pre-existing components that have been modified accordingly.

Some printers and/or imaging devices have the ability to send a notification notice back to the originator upon successful completion and/or termination of a print job. Examples of such devices that support this capability are the Sharp AR-335/6/7, AR-405/7, AR-505/7, AR-M/P 350, AR-M/P 450, AR-235/N, AR-275/N and Ricoh Alficio 1022.

Generally speaking, the printing device 120 obtains the network address of the originating computing device 102 by extracting it from the print job. One method is to embed a PJL (Printer Job Language) statement indicating the IP address of the originating computing device 102 and a port of a monitoring process on the computing device 102. The device 120 would then send job completion notifications to the specified port at the specified IP address.

The systems and methods described herein may be independent of the method to initiate the print job, and the method of transmitting the print job to a printing device. There are several different ways in which the print job may be initiated. For example, the print job may be generated by a printer driver from an application. The application may convert the document into printing instructions, such as GDI (i.e., Graphics Device Interface) in the Microsoft Windows® family of operating systems. The printing instructions would then be passed to a printer driver installed on the client and/or server associated with the printing device. The printer driver would then convert the printing instructions into a printer dependent format, such as a raster image or PDL. In other cases, such as Direct Printing, the document format can be directly interpreted by the printer and there is no preprocessing of the document format into a printer dependent format.

The systems and methods herein may be independent of the method by which the device confirms the job completion to a monitoring process or program. For example, the device may send an SNMP (Simple Network Management Protocol) message, via trap, send an email message, or use a proprietary protocol such as Sharp NJR to the monitoring process or program.

Those skilled in the art will appreciate that the present systems and methods may be implemented in many different embodiments. Other embodiments include but are not limited to the spooling and despooling subsystems of the Apple Macintosh operating system, the Linux operating system, System V Unix operating systems, BSD Unix operating systems, OSF Unix operating systems, and IBM Mainframe MVS and AS/400 operating system.

Although use with a printer was illustrated, it will be appreciated that the present systems and methods may be applied to other embodiments. For example, the present systems and methods may be applied to fax, scan and document management operations.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A method for monitoring an imaging job in a computer system, the method comprising:
sending an imaging job to an imaging device;
creating a background process on a computer system for monitoring the status of the imaging job, wherein the computer system includes a despooling subsystem, and
wherein the background process is initiated by the despooling subsystem;
obtaining a network address of a computing device;
sending a status message to the computing device using the network address; and
receiving the status message by the background process.

2. The method of claim 1, further comprising delaying return to a print spooler until after the imaging job is completed.

3. The method of claim 1, further comprising taking control of descheduling and clearing of the imaging job from a print spooler by a print processor.

4. The method of claim 1, wherein the imaging device is selected from the group consisting of a printer, a scanner, a fax machine, a copier and a document server.

5. The method of claim 1, further comprising using a protocol for communications between the computing device and the imaging device.

6. The method of claim 1, further comprising embedding the network address in the imaging job.

7. The method of claim 1, further comprising extracting the network address from a connection.

8. The method of claim 1, further comprising sending the network address from the computing device to the imaging device.

9. The method of claim 1, wherein the status message includes an identifier that enables the computing device to direct the status message to the processing listening for the message, and wherein the identifier is selected from the group consisting of a port, a file, a directory, an FTP address, an SNMP trap and an email address.

10. The method of claim 2, further comprising notifying a print processor of the status message after the status message has been received by the background process.

11. The method of claim 10, further comprising terminating the background process.

12. The method of claim 11, further comprising returning control back to the print spooler and indicating success/failure of the imaging job to the print spooler.

13. The method of claim 12, further comprising performing job recovery by the print spooler if the job recovery is necessary.

14. The method of claim 1, further comprising returning control back to the print spooler.

15. The method of claim 1, further comprising descheduling and clearing of the imaging job by the background process.

16. The method of claim 1, wherein the background process runs asynchronously.

17. A set of executable instructions for implementing a method in a computing device for monitoring an imaging job, the method comprising:
sending an imaging job to an imaging device;
creating a background process for monitoring the status of the imaging job, wherein the background process is initiated by a despooling subsystem;
obtaining a network address of a computing device;
sending a status message to the computing device using the network address; and
receiving the status message by the background process.

18. The set of executable instructions of claim 17, further comprising delaying return to a print spooler until after the imaging job is completed.

19. The set of executable instructions of claim 17, further comprising taking control of descheduling and clearing of the imaging job from a print spooler by a print processor.

20. The set of executable instructions of claim 18, further comprising notifying a print processor of the status message after the status message has been received by the background process.

21. The set of executable instructions of claim 17, further comprising a computer-readable medium for storing the executable instructions.

22. A system for monitoring an imaging job in a computer system, the system comprising:
a computing device;
an imaging device in electronic communication with the computing device;
executable instructions executable on the computing device, wherein the executable instructions are configured to implement a method comprising:
sending an imaging job to an imaging device;
creating a background process for monitoring the status of the imaging job,
wherein the computer device includes a despooling subsystem, and
wherein the background process is initiated by the despooling subsystem;
obtaining a network address of a computing device;
sending a status message to the computing device using the network address; and
receiving the status message by the background process.

23. The system of claim 22, further comprising delaying return to a print spooler until after the imaging job is completed.

24. The system of claim 22, further comprising taking control of descheduling and clearing of the imaging job from a print spooler by a print processor.

25. The system of claim 22, further comprising notifying a print processor of the status message after the status message has been received by the background process.
